(19) United States
(12) Patent Application Publication
(10) Pub. No.: US 2026/0255338 A1
(43) Pub. Date: Aug. 27, 2026

(54) USER EQUIPMENT SCHEDULING ASSISTANCE FOR MODE 1 SIDELINK COMMUNICATIONS

(71) Applicant: QUALCOMM INCORPORATED, San Diego, CA (US)

(72) Inventors: Shuanshuan WU, San Diego, CA (US); Kapil GULATI, Belle Mead, NJ (US); Tien Viet NGUYEN, Bridgewater, NJ (US); Hui GUO, Beijing (CN)

(21) Appl. No.: 18/994,355

(22) PCT Filed: Sep. 1, 2022
(86) PCT No.: PCT/CN2022/116436

§ 371 Date: Jan. 14, 2025

(51) Int. Cl. H04W 72/1263; H04W 72/25; H04W 72/40; H04W 92/18

(52) U.S. Cl. CPC H04W 72/1263; H04W 72/25; H04W 72/40; H04W 92/18

(57) ABSTRACT

Methods, systems, and devices for wireless communications are described. In some examples, a user equipment (UE) may transmit, to a network entity and via an uplink communication link, scheduling assistance information (SAI) that indicates a first set of sidelink resources for sidelink communications by the UE. The UE may determine the first set of sidelink resources based on monitoring for sidelink control information (SCI) from one or more other UEs, based on coordination messages received from one or more other UEs, or both. The UE may receive a scheduling message from the network entity that allocates a second set of sidelink resources for the sidelink communications by the UE based on the first set of sidelink resources indicated via the SAI. The UE may transmit a sidelink message to another UE via the second set of sidelink resources allocated by the scheduling message.

### CROSS REFERENCE

The present Application is a 371 national stage filing of International PCT Application No. PCT/CN2022/116436 by Wu et al. entitled “USER EQUIPMENT SCHEDULING ASSISTANCE FOR MODE 1 SIDELINK COMMUNICATIONS,” filed Sep. 1, 2022, which is assigned to the assignee hereof, and which is expressly incorporated by reference in its entirety herein.

### FIELD OF TECHNOLOGY

The following relates to wireless communications, including user equipment (UE) scheduling assistance for Mode 1 sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE communicating over sidelink may perform a channel sensing procedure to identify resources available for sidelink transmission of a sidelink message. In some other systems, a network entity may allocate resources for the UE to use for transmitting the sidelink message. In such cases, the network entity may schedule sidelink communications by one or more UEs in a cell supported by the network entity.

### SUMMARY

The described techniques relate to improved methods, systems, devices, and apparatuses that support user equipment (UE) scheduling assistance for Mode 1 sidelink communications. For example, the described techniques provide for a UE to transmit sidelink scheduling assistance information (SAI) to a network entity to assist with scheduling sidelink communications by the UE. The SAI may indicate a set of sidelink resources that are preferred (e.g., available) or non-preferred (e.g., reserved or associated with relatively high interference) for sidelink transmissions by the UE. The UE may determine the set of sidelink resources based on a sidelink channel sensing procedure performed by the UE, based on inter-UE coordination information received from another UE, or both. For example, the UE, one or more other UEs, or both may monitor a sidelink resource pool for sidelink control information (SCI) transmitted by other UEs. The SCI may indicate sidelink resources reserved for transmissions by the other UEs. The UE may indicate resource preference information (e.g., non-preferred resources from the reserved resources or preferred resources from the resources that are not indicated as reserved via the SAI) or the UE may receive an inter-UE coordination message that indicates resource preference information (e.g., resources from the reserved resources or resources that are not indicated as reserved), and the UE may forward the indication via the SAI, or both. Accordingly, the SAI may be based on such sidelink channel sensing procedures. The network entity may transmit a scheduling message to the UE to grant sidelink resources for sidelink transmissions by the UE based on the set of resources (e.g., preferred or non-preferred resources) indicated via the SAI.

### BRIEF DESCRIPTION OF THE DRAWINGS

FIG. 1 illustrates an example of a wireless communications system that supports user equipment (UE) scheduling assistance for Mode 1 sidelink communications in accordance with one or more aspects of the present disclosure.

FIG. 2 illustrates an example of a wireless communications system that supports UE scheduling assistance for Mode 1 sidelink communications in accordance with one or more aspects of the present disclosure.

FIG. 3 illustrates an example of a sidelink resource reservation scheme that supports UE scheduling assistance for Mode 1 sidelink communications in accordance with one or more aspects of the present disclosure.

FIG. 4 illustrates an example of a process flow that supports UE scheduling assistance for Mode 1 sidelink communications in accordance with one or more aspects of the present disclosure.

FIGS. 5 and 6 show block diagrams of devices that support UE scheduling assistance for Mode 1 sidelink communications in accordance with one or more aspects of the present disclosure.

FIG. 7 shows a block diagram of a communications manager that supports UE scheduling assistance for Mode 1 sidelink communications in accordance with one or more aspects of the present disclosure.

FIG. 8 shows a diagram of a system including a device that supports UE scheduling assistance for Mode 1 sidelink communications in accordance with one or more aspects of the present disclosure.

FIGS. 9 and 10 show block diagrams of devices that support UE scheduling assistance for Mode 1 sidelink communications in accordance with one or more aspects of the present disclosure.

FIG. 11 shows a block diagram of a communications manager that supports UE scheduling assistance for Mode 1 sidelink communications in accordance with one or more aspects of the present disclosure.

FIG. 12 shows a diagram of a system including a device that supports UE scheduling assistance for Mode 1 sidelink communications in accordance with one or more aspects of the present disclosure.

FIGS. 13 through 16 show flowcharts illustrating methods that support UE scheduling assistance for Mode 1 sidelink communications in accordance with one or more aspects of the present disclosure.

### DETAILED DESCRIPTION

Some wireless communication systems may support an autonomous sidelink resource allocation mode (e.g., Mode 2 sidelink communications) in which a user equipment (UE) may perform a sidelink channel sensing procedure to determine available sidelink resources to use for sidelink transmissions by the UE. In some examples, the sidelink channel sensing procedure by the UE may be assisted by an inter-UE coordination message from a receiving UE. The inter-UE coordination message may indicate resources that are preferred or non-preferred by the receiving UE for sidelink communications. In some other examples, a wireless communications system may support a different sidelink resource allocation mode (e.g., Mode 1 sidelink communications), in which a network entity may allocate resources to a UE for sidelink transmissions within a cell supported by the network entity. The network entity may determine which sidelink resources are available based on scheduling information at the network entity (e.g., previous resource grants or allocations by the network entity). However, the network entity may not monitor or receive scheduling information transmitted by other neighboring network entities that support other cells, which may result in collisions between sidelink transmissions granted by neighboring network entities.

Techniques, systems, and devices described herein provide for a UE to transmit scheduling assistance information (SAI) to a network entity to improve reliability of sidelink resource allocations for Mode 1 sidelink communications. The SAI may indicate sidelink resources that are preferred or non-preferred for sidelink transmissions by the UE. The preferred resources may be sidelink resources that are available or are not being used by other UEs. The non-preferred resources may be sidelink resources that are reserved for sidelink transmissions by other UEs in a same or different cell. The UE may determine the preferred or non-preferred resources based on a sidelink channel sensing procedure performed by the UE, based on inter-UE coordination information received from one or more other UEs, or both. Although sidelink resources may be granted by a network entity during Mode 1 sidelink communications, the UEs may transmit, via the sidelink messages, sidelink control information (SCI) associated with the sidelink messages, or both, an indication of the granted (e.g., reserved) resources in future slots. Accordingly, the UE, one or more other UEs, or both may monitor a sidelink resource pool for SCI from other UEs to determine sidelink resources availability or preference.

The SAI may be based on such sidelink channel sensing procedures. If the UE performs the sidelink channel sensing, the UE may indicate non-preferred resources (e.g., one or multiple of the reserved resources) or preferred resources (e.g., one or multiple of the resources that are determined as available, or not reserved) to the network entity via the SAI based on the sidelink channel sensing procedure. If one or more other UEs perform sidelink channel sensing, the one or more other UEs may transmit inter-UE coordination messages to the UE to indicate the preferred resources or the non-preferred resources based on the sidelink channel sensing procedures, and the UE may forward the one or more indications (e.g., the UE may aggregate the feedback) to the network entity via the SAI. In some examples, the UE may aggregate the results of a sidelink channel sensing procedure performed by the UE with resources indicated via one or more inter-UE coordination messages, and the UE may transmit the aggregated resource preference to the network entity via the SAI. The network entity may transmit a scheduling message to grant resources for sidelink transmissions by the UE based on the sidelink resources indicated via the SAI. The UE may transmit a sidelink message to one or more other UEs in the same or different cell as the UE via the granted resources.

The SAI described herein may support increased reliability and decreased interference for sidelink communications, among other advantages and improvements. For example, by scheduling sidelink resources based on the SAI, the network entity may account for sidelink resources granted by other network entities in other wireless cells. As such, the network entity may schedule sidelink transmissions for the UE via resources that may not interfere with sidelink transmissions scheduled by other network entities in other cells, which may decrease interference and sidelink collisions. Such sidelink resource allocation techniques may thereby decrease latency, improve throughput, and improve sidelink communication reliability.

Aspects of the disclosure are initially described in the context of wireless communications systems. Additional aspects of the disclosure are described with reference to a sidelink resource reservation scheme and a process flow. Aspects of the disclosure are further illustrated by and described with reference to apparatus diagrams, system diagrams, and flowcharts that relate to UE scheduling assistance for Mode 1 sidelink communications.

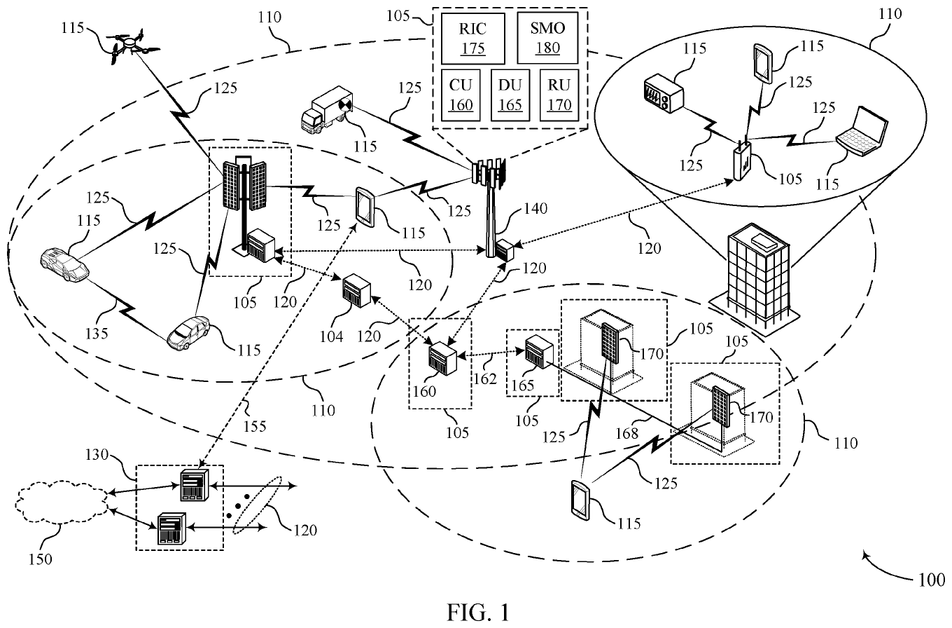

FIG. 1 illustrates an example of a wireless communications system 100 that supports UE scheduling assistance for Mode 1 sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support UE scheduling assistance for Mode 1 sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support sidelink communications between two or more wireless devices (e.g., UEs 115). The wireless communications system 100 may support one of two sidelink communication modes: Mode 1 and Mode 2. In Mode 1 sidelink communications, a UE 115 may request resources to from a network entity 105 for transmission. The UE 115 (e.g., a vehicle to device (V2X) UE 115, or some other wireless device) may send a scheduling request, a sidelink buffer status report (BSR), or both for a sidelink transmission to the network entity 105. The network entity 105 may allocate sidelink resources by transmitting a control message (e.g., downlink control information (DCI)) on an access link (e.g., Uu link) to grant one or more resources for the sidelink transmission. The UE 115 may perform a transmission to another UE 115 on a sidelink (e.g., PC5 link) using the one or more resources. In some examples, the sidelink transmission may include SCI, data, or both. The SCI may inform other receiving UEs 115 about the resource reservation, such that nearby UEs 115 operating under Mode 1 sidelink communications may refrain from using the sidelink resources reserved for transmissions by the UE 115.

In some examples, the network entity 105 may grant multiple resources for transmissions by the UE 115 over time (e.g., resources in a quantity of slots, or resources allocated according to an indicated periodicity, or both), and the UE 115 may indicate the granted resource in future slots to other receiving UEs 115 via the SCI. The UE 115 may communicate with another UE 115, and the other UE 115 may be in a same cell as the UE 115 or a different cell (e.g., sidelink communications may not be limited by cell boundaries). To facilitate sidelink communications between cells, a sidelink resource pool configuration may be aligned across cells. For example, if a resource in a first slot of a resource pool is reserved for transmission by a UE 115 associated with a first cell, the same resource in the same slot may also be indicated as reserved in the sidelink resource pool indicated in another cell (e.g., an aligned resource pool configuration). The aligned resource pool configuration may provide for UEs 115 to transmit and receive sidelink communications regardless of cell association. Due to the aligned sidelink resource pool across cells, a UE 115 may monitor (e.g., blindly decode) for potential resource reservations from other UEs 115 in each resource of the configured sidelink resource pool.

During Mode 1 sidelink communications, the network entity 105 that schedules sidelink communications may not monitor for or receive scheduling information transmitted by other neighboring network entities 105 associated with other cells, which may result in collisions between sidelink transmissions granted by different network entities 105 in different cells. For example, a first network entity 105 in a first cell may reserve a first resource in a sidelink resource pool for a first UE 115. The UE 115 may use the first resource for a transmission to a second UE 115 in a second cell, but a second network entity 105 associated with the second UE 115 (e.g., the target UE 115) may be unaware of the reservation of the first resource. The second network entity 105 may, in some cases, schedule a resource reservation that may overlap with the second resource reserved for the first UE 115, and the respective transmissions may collide, which may result in decreased reliability in sidelink communications and interference at the receiving UE 115.

In Mode 2 sidelink communications, a UE 115 may autonomously select sidelink resources from a sidelink resource pool to use for transmissions based on a sidelink channel sensing procedure. To perform the sidelink channel sensing procedure, the UE 115 may monitor for and decode SCI transmitted by other UEs 115. The SCI may indicate resource that are reserved by the other UEs 115 for transmissions in future slots in a resource pool. In some examples, the UE 115 may perform a reference signal received power (RSRP) measurement of the SCI to determine which resources to reserve during a resource selection window. The UE 115 may select available resources based on the sidelink channel sensing procedure to avoid collisions that may occur if multiple UEs 115 reserve the same resource for the sidelink transmission (e.g., collisions from a hidden node). The UE 115 may reserve the sidelink resources by transmitting SCI to other UEs 115.

The sidelink channel sensing procedure by the UE 115 may be assisted, in some cases, by an inter-UE coordination message from another UE 115. For example, the other UE 115 may transmit an inter-UE coordination message to the UE 115. The inter-UE coordination message may include a resource preference indication. The inter-UE coordination message may be request-based or condition-based, where the UE 115 may request the inter-UE coordination message from the other UE 115, or the other UE 115 may determine whether to transmit the inter-UE coordination based on a condition.

Techniques, systems, and devices described herein provide for a UE 115 to transmit SAI to a network entity 105 to improve reliability of sidelink resource allocations for Mode 1 sidelink communications. The SAI may indicate sidelink resources that are preferred or non-preferred for sidelink transmissions by the UE 115. The UE 115 may determine the preferred or non-preferred resources based on a sidelink channel sensing procedure performed by the UE 115, based on inter-UE coordination information received from one or more other UEs 115, or both. The sidelink resources indicated via the SAI may be based on such sidelink channel sensing procedures. The network entity 105 may transmit a scheduling message to grant resources for sidelink transmissions by the UE 115 based on the preferred or non-preferred resources indicated via the SAI, which may increase reliability and decrease interference associated with sidelink communications.

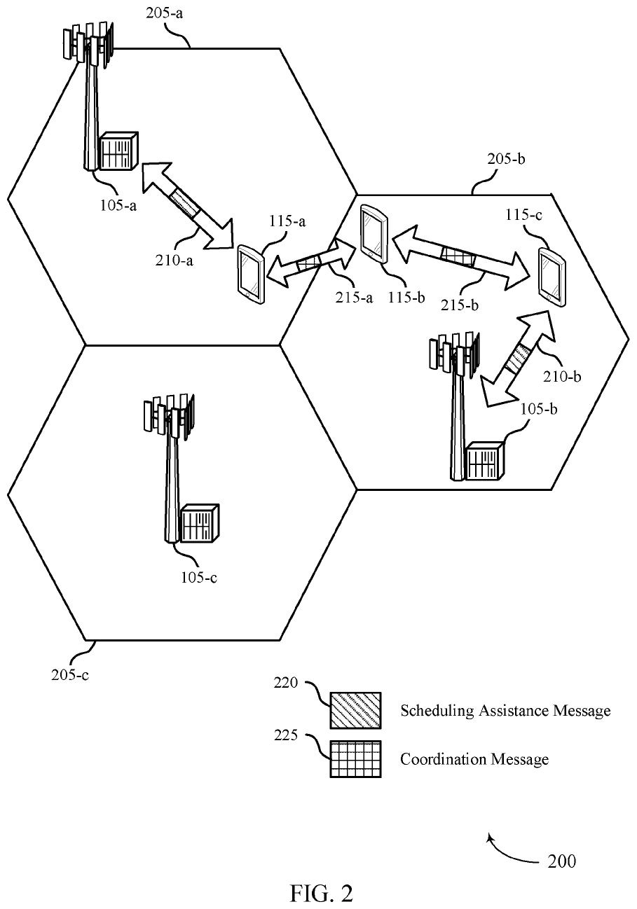

FIG. 2 illustrates an example of a wireless communications system 200 that supports UE scheduling assistance for Mode 1 sidelink communications in accordance with one or more aspects of the present disclosure. In some examples, the wireless communications system 200 may implement aspects of the wireless communications system 100. For example, the wireless communications system 200 may support communications between a network entity 105-a, a network entity 105-b, a network entity 105-c, a UE 115-a, a UE 115-b, and a UE 115-c, which may be examples of corresponding network entities 105 and UEs 115 as described with reference to FIG. 1. In some examples, a network entity 105 may communicate with one or more UEs 115 via a wireless link 210 within a cell 205 (e.g., a cell 205-a, a cell 205-b, a cell 205-c). For example, the network entity 105-a may perform a downlink transmission to the UE 115-a via the wireless link 210-a within the cell 205-a. In another example, a UE 115 may perform sidelink communications via a sidelink communication link 215 with another UE 115 within a cell 205, or across cells 205. For example, the UE 115-a in the cell 205-a may transmit a sidelink transmission via a sidelink communication link 215-a to the UE 115-b in the cell 205-b.

The UEs 115 in the wireless communications system 200 may support sidelink communications according to a first mode or a second mode of sidelink resource allocation (e.g., sidelink resource allocation Mode 1 or sidelink resource allocation Mode 2). For Mode 1 sidelink resource allocations, a network entity 105 may allocate resources to a transmitting UE 115 for transmissions by the UE 115, as described in further detail with reference to FIG. 1. Techniques, systems, and devices described herein provide for a UE 115 to transmit a scheduling assistance message 220 to a network entity 105 to improve reliability of sidelink resource allocation for Mode 1 sidelink communications. The scheduling assistance message 220 may include SAI that may indicate one or more sidelink resources for sidelink communications by the UE 115. The UE 115 may determine the SAI autonomously based on sidelink channel sensing performed at the UE 115, based on information received via an inter-UE coordination message 225 received from another UE 115, or both.

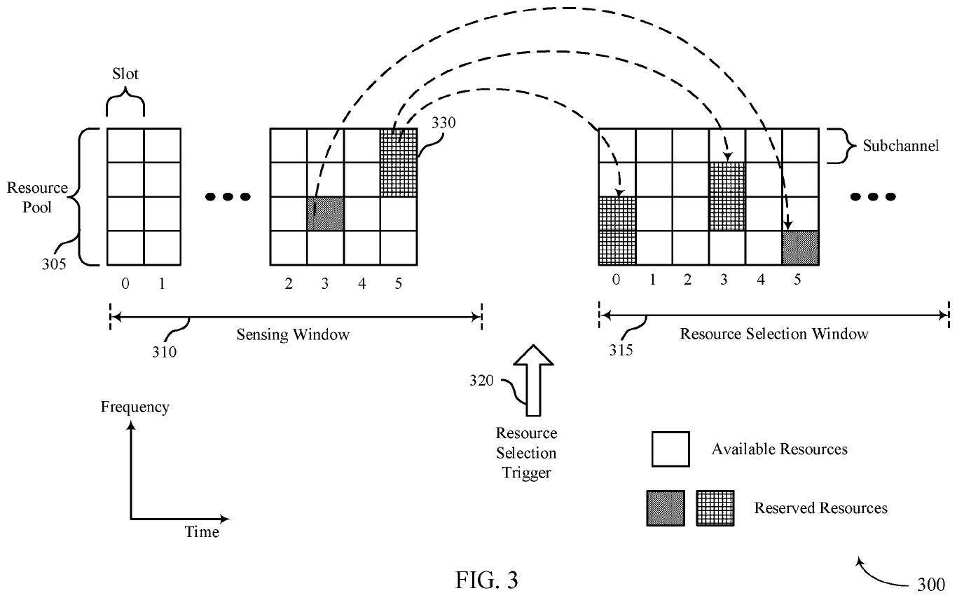

In the example of FIG. 2, the UE 115-c may transmit a scheduling assistance message 220 to the network entity 105-b to indicate preferred or non-preferred resources for transmissions by the UE 115-c. The network entity 105-b may schedule or allocate sidelink resources for transmissions by the UE 115-c based on the SAI included in the scheduling assistance message 220. In some examples, to determine the SAI, the UE 115-c may perform a sidelink channel sensing procedure to monitor for resource reservation information, such as SCI, from one or more other UEs 115 in the same or different cells 205, such as the UE 115-a, the UE 115-b, or both. Techniques for monitoring for resource reservation information and performing the sensing procedure may be described in further detail elsewhere herein, including with reference to FIG. 3.

The SCI may indicate a set of sidelink resources that are reserved for sidelink transmissions by the one or more other UEs 115. In some examples, the UE 115-c may be unaware of whether the resources indicated in the SCI may be reserved by a UE 115 that is in the same cell 205-b as the UE 115-c, such as the UE 115-b, or in a different cell 205 than the UE 115-c, such as the UE 115-a in the cell 205-a. In this example, the UE 115-c may indicate each of the resources that are reserved via the scheduling assistance message 220 (e.g., non-preferred resources), or the UE 115-c may indicate each of the resources that are not reserved via the scheduling assistance message 220 (e.g., preferred or available resources). The network entity 105-b may determine whether the reserved resources indicated via the scheduling assistance message 220 were reserved by the network entity 105-b in the cell 205-b or were reserved (e.g., allocated, scheduled) by another network entity 105 in a different cell 205, such as the network entity 105-a or the network entity 105-c.

In some examples, the SCI received by the UE 115-b may include a cell identifier (ID) corresponding to cell associated with a resource reservation by another UE 115. The cell ID may indicate whether the resources indicated in the SCI are reserved by a UE 115 in the same cell 205-b as the UE 115-c or in a different cell 205 than the UE 115-c. If the cell ID is included in the SCI, the UE 115-c may determine which sidelink resources to indicate via the scheduling assistance message 220 based on the cell IDs associated with the resource reservations indicated in the SCI. For example, the UE 115-c may indicate reserved resources in a neighboring cell 205 that is different than the cell 205-b supported by the network entity 105-b, and the UE 115-c may refrain from indicating reserved resources in the same cell 205-b via the scheduling assistance message 220 (e.g., because the network entity 105-b may have knowledge of the scheduled and reserved resources within the cell 205-b), which may reduce overhead. The scheduling assistance message 220 may indicate a set of sidelink resources that may be preferred (e.g., preferred resources) or may not be preferred (e.g., non-preferred resources) for sidelink communications by the UE 115-c. For example, the UE 115-c may report a resource to the network entity 105-b as being not preferred if the cell ID indicates that the resources were reserved by a UE 115 in a different cell 205.

In some examples, the UE 115-b may transmit a coordination message 225 to the UE 115-c via sidelink communication link 215-b. The coordination message 225 may indicate a set of resources based on SCI received by the UE 115-b during a sidelink channel sensing procedure performed by the UE 115-b. The coordination message 225 may include a resource preference indication, a cell ID, or both associated with the set of resources. The resource preference indication may indicate whether the set of resources are preferred resources or non-preferred resources. Preferred resources may be one or more available resources (e.g., resources that are not reserved by other UEs 115 via SCI), and non-preferred resources may be one or more unavailable resources (e.g., resource reserved by other UEs 115), in some examples. In some examples, the resource preference indication may include one or more non-preferred resources from a set of resources that are reserved for transmissions by other UEs 115 or one or more preferred resources from a set of resources that are not indicated as reserved by other UEs 115.

For example, the UE 115-b may transmit a coordination message 225 to the UE 115-c, and the coordination message 225 may include an indication of a reservation made by another UE 115 in another cell, such as by the UE 115-a in the cell 205-a. The coordination message 225 may indicate that the resource reserved by the UE 115-a is a non-preferred resource. The UE 115-c may receive the coordination message 225 from the UE 115-b and forward the some or all of the resource reservation information indicated via the coordination message 225 to the network entity 105-b via the SAI in the scheduling assistance message 220. For example, if the coordination message 225 indicates preferred or non-preferred resources, the UE 115-c may indicate such resource preferences to the network entity 105-b via the SAI.

In some examples, the UE 115-c may receive multiple coordination messages 225 from multiple UEs 115. The UE 115-c may combine (e.g., aggregate) the resources and other information indicated via the multiple coordination messages 225 and report the resource reservations to the network entity 105-b as part of the scheduling assistance message 220. For example, if the UE 115-c receives multiple coordination messages 225 indicating multiple preferred resources, the UE 115-c may transmit a scheduling assistance message 220 to the network entity 105-b that indicates resources that are common to each of the coordination messages 225 (e.g., an intersection of the resources). If the UE 115-c receives multiple coordination messages 225 indicating multiple non-preferred resources, the UE 115-c may transmit a scheduling assistance message 220 to the network entity 105-b with a combination of the resources (e.g., a union of the resources).

In some examples, the SAI may be based on a sidelink channel sensing procedure performed by the UE 115-c and one or more coordination messages 225 received from other UEs 115. For example, the UE 115-a may determine available or unavailable resources based on sensing and receiving performed by the UE 115-a (e.g., reservation information indicated via SCI, RSRP measurements of decoded transmissions, or both). The UE 115-a may transmit a coordination message 225 to the UE 115-c to indicate the resource preference information (e.g., available or unavailable resources). The UE 115-b may, in some examples, perform a similar procedure to indicate resource preference information to the UE 115-c. The UE 115-c may determine available or unavailable resources based on sensing and receiving performed by the UE 115-a (e.g., reservation information indicated via SCI, RSRP measurements of decoded transmissions, or both). The UE 115-c may determine resource preference information based on the availability identified by the UE 115-c in addition to the preference information received via the coordination message(s) 225. The UE 115-c may aggregate the resource preference information and transmit the aggregated resource preference information via the SAI.

The UE 115-c may determine whether to use a sidelink channel sensing procedure at the UE 115-c, use one or more coordination messages 225, or use a combination of both to determine the resource preference information to transmit via the SAI based on a capability of the UE 115-c, an indication via signaling from the network entity 105-b, a defined rule or standard, or any combination thereof. For example, the UE 115-c may, in some examples, not be capable of sidelink sensing (e.g., a power sensitive UE 115). In such cases, the UE 115-c may use coordination messages 225 from other UEs 115 to determine what resource preference information to report (e.g., and the UE 115-c may refrain from performing a sidelink channel sensing procedure). Additionally, or alternatively, the network entity 105-b may determine to use one of the methods, and the network entity 105-b may indicate the selection to the UE 115-c via control signaling or may configure the selection per resource pool configuration.

The UE 115-c transmit the scheduling assistance message 220 to the network entity 105-b via the wireless link 210-b within the cell 205-b (e.g., a Uu link, an uplink communication link). The scheduling assistance message 220 may indicate a set of sidelink resources that may be preferred or may not be preferred for sidelink communications by the UE 115-c. The scheduling assistance message 220 may be transmitted via one or more of a medium access control-control element (MAC-CE), a sidelink BSR, or a physical uplink control channel (PUCCH) transmission, from the UE 115-c to the network entity 105-b.

The network entity 105-b may indicate to the UE 115-c to report the resource reservations included in the scheduling assistance message 220. In some examples, the network entity 105-b may transmit DCI to the UE 115-c, and the DCI may dynamically trigger the UE 115-c to transmit the scheduling assistance message 220. For example, a field in the DCI may include the trigger indication. In another example, the network entity 105-b may transmit some other signaling, such as a MAC-CE, or an RRC message to enable reporting by the UE 115-c of the scheduling assistance message 220. In some other examples, the network entity 105-b may transmit other signaling, such as a system information block (SIB), to enable reporting for one or more UEs 115 in the cell 205-b, such as the UE 115-c and the UE 115-b. The control signaling transmitted by the network entity 105-b may indicate whether the resource preference reporting by the UE 115-c includes preferred resource information, non-preferred resource information, or both.

Additionally, or alternatively, the UE 115-c may transmit the scheduling assistance message 220 based on a set of conditions. For example, the UE 115-c may determine whether to transmit based whether the UE 115-c has received a coordination message 225 from another UE 115, whether the UE 115-c has experienced degraded sidelink performance, whether the UE 115-c has determined that the channel is associated with a relatively high channel busy ratio (CBR), or any combination thereof. The UE 115-c may determine the degraded sidelink performance based on whether the UE 115-c receives a quantity of consecutive negative acknowledgments (NACKs) (e.g., greater than a threshold quantity), based on a ratio of received NACKs to received ACKs exceeding a threshold NACK ratio, or both. The UE 115-c may measure the CBR for a sidelink resource pool based and compare the measured CBR with a CBR threshold. If the measured CBR exceeds the CBR threshold, the UE 115-c may transmit the scheduling assistance message 220.

In response to the scheduling assistance message 220, the network entity 105-b may transmit a scheduling message (e.g., a scheduling grant) to the UE 115-c via the wireless link 210-b. The scheduling message may allocate or schedule a set of sidelink resources for sidelink transmissions by the UE 115-c. The scheduling message may be based on the SAI indicated via the scheduling assistance message 220. For example, the scheduling message may indicate resource reservations based on the resources indicated via the scheduling assistance message 220. If the scheduling assistance message 220 indicates resources that are preferred by the UE 115-c, the network entity 105-b may be more likely to select at least some of those resources. If the scheduling assistance message 220 indicates resources that are not preferred by the UE 115-c, the network entity 105-b may attempt to refrain from allocating or scheduling those resources. The network entity 105-b may additionally, or alternatively, account for other communications in the cell 205-b when scheduling the sidelink communications. The UE 115-c may use the set of sidelink resources indicated in the scheduling message to transmit a sidelink message to a UE 115-b, the UE 115-a, or both.

UEs 115 as described herein may thereby generate and transmit a scheduling assistance message 220 to a network entity 105 to report sidelink resources for sidelink communications by the UEs 115. The sidelink resources may be determined based on a sidelink channel sensing procedure performed by one or more of the UEs 115 in the same or different cells 205, and may assist the network entity 105 in identifying available sidelink communications. The described techniques may thereby provide for improved communication reliability and coordination between devices.

FIG. 3 illustrates an example of a sidelink resource reservation scheme 300 that supports UE scheduling assistance for Mode 1 sidelink communications in accordance with one or more aspects of the present disclosure. In some examples, the sidelink resource reservation scheme 300 may represent a sidelink resource reservation scheme used by a first UE 115 (e.g., a transmitting UE 115) to select sidelink resources for transmitting a sidelink message. The first UE 115 may communicate with one or more second UEs 115 using resources 330 (e.g., time and frequency resources) in a resource pool 305 over a sidelink channel. The first UE 115 and the one or more second UEs 115 may be examples of the UEs 115 described with reference to FIGS. 1 and 2. In some examples, the first UE 115 may determine resources to indicate via a scheduling assistance message as part of the scheduling assistance procedure.

Some sidelink communications (e.g., V2X communications, or other device-to-device communications) may support autonomous resource allocation by a UE 115 (e.g., a Mode 2 resource allocation). For example, the first UE 115 may identify available resources (e.g., time and frequency resources, such as resources 330 in slots and subchannels) of a resource pool 305 for a sidelink transmission. The first UE 115 may select one or more resources for the sidelink transmission from the resources in the resource pool 305 (e.g., a pool of time and frequency resources). In some examples, the UE 115 may receive an indication of the preferred resources, non-preferred (e.g., unavailable) resources, or both via a sidelink transmission from another UE (e.g., an inter-UE coordination message).

In the example of FIG. 3, the first UE 115 and the one or more second UEs 115 may operate according to Mode 1 sidelink communications, as described with reference to FIGS. 1 and 2. However, the first UE 115, the one or more second UEs 115, or both, may perform a sidelink channel sensing procedure to identify resources to indicate via SAI to the network entity 105. The indicated resources may be preferred (e.g., available) or non-preferred (e.g., reserved) for sidelink transmissions by the first UE 115, and may improve reliability and efficiency of the sidelink resource allocations by the network entity 105 during Mode 1 sidelink communications.

The sidelink channel sensing procedure may be triggered by a resource selection trigger 320, in some aspects. The resource selection trigger 320 may be a signal received by a UE 115 or may correspond to one or more conditions being satisfied, or both. A UE 115 may monitor one or more sidelink resources in the resource pool 305. The resource pool 305 may be aligned across one or more cells, as described with reference to FIG. 2. When the sidelink channel sensing procedure is triggered, resources previously monitored by the UE 115 may correspond to a sensing window 310, and future resources from which the UE 115 may select, may correspond to a resource selection window 315.

In the sidelink resource reservation scheme 300, the UE 115 may monitor each resource 330 within the resource pool 305 during the sensing window 310 to identify available resources of the resource pool 305 within a corresponding resource selection window 315. The UE 115 may indicate one or more of the available resources in the resource selection window 315 (e.g., preferred resources), one or more of the reserved resources in the resource selection window 315 (e.g., non-preferred resources) or both via SAI, via an inter-UE coordination message, or both. All of the resources within slots 0 through 5 and subchannels 0 through 3 of the resource selection window 315 may be included in a set of resources for the UE 115 to select from and indicate via the SAI. The UE 115 may monitor for SCI from one or more other UEs 115 and perform sidelink channel sensing to determine a measured signal metric level (e.g., RSRP) associated with each resource 330 in the sensing window 310. The SCI may indicate one or more resources in a resource selection window 315 that may be reserved for a future transmission by another UE 115. The UE 115 may group the one or more reserved resources, and the UE 115 may determine that the remaining resources in the resource selection window 315 are available resources.

In some examples, the UE 115 may measure an RSRP level of SCI or other signaling received during the sensing window 310 and compare the measured RSRP with an RSRP threshold. If the measured RSRP is below the RSRP threshold, the UE 115 may include the corresponding resources in the set of available resources (e.g., the UE 115 may determine that transmissions via the resources may not interfere with transmissions by the UE 115). If the measured RSRP is below the RSRP threshold, the UE 115 may determine that a transmission in the one or more resources scheduled by the SCI are unlikely to cause significant interference with a transmission by the UE 115 in the resource. The RSRP threshold may be configured by the network entity 105 and indicated to the UE 115 via control signaling, such as RRC signaling, or some other control signaling.

When the first UE 115 receives or detects resource selection trigger 320, the UE 115 may identify the sensing window 310 (e.g., a window in the past) and the resource selection window 315 (e.g., a window in the future), and the UE 115 may perform resource selection. For example, the first UE 115 may determine a set of available resources in the resource selection window 315 based on SCI decoding, RSRP measurement, or both in the sensing window 310.

If the first UE 115 performs the sidelink channel sensing procedure, the first UE 115 may indicate one or more of the available resources (e.g., preferred resources) or one or more of the reserved resources (e.g., non-preferred resources) in the resource selection window 315 to the network entity 105 via SAI (e.g., via a scheduling assistance message). If one or more of the second UEs 115 perform the sidelink channel sensing procedure, the one or more second UEs 115 may transmit an indication of one or more of the available resources (e.g., preferred resources) or one or more of the reserved resources (e.g., non-preferred resources) in the resource selection window 315 to the first UE 115 via an inter-UE coordination message. The first UE 115 may aggregate the resource preference information received from the one or more second UEs 115 and indicate the aggregated information to the network entity 105 via the SAI. In some other examples, the first UE 115 may combine resource preference information determined by the UE 115 with resource preference information determined by the one or more second UEs 115, and the UE 115 may indicate the combined resource preference information via the SAI, as described with reference to FIG. 2. The SAI may indicate the time and frequency location of each of the preferred or non-preferred resources (e.g., a corresponding slot and subchannel).

After identifying available resources of the resource pool 305 within the resource selection window 315, the first UE 115 may select a resource for transmission of the scheduling assistance message to the network entity 105. In some aspects, the network entity 105 may allocate a resource for the UE 115 to use for transmission of the scheduling assistance message. The sidelink resources indicated via the scheduling assistance message may be within a threshold time period of the resources via which the scheduling assistance message is transmitted. For example, if the first UE 115 transmits the scheduling assistance message in a first slot, n, the scheduling assistance message may include an indication of resources that are between a first time period n+m1 and n+m2, where m1<m2. In the example of FIG. 3, if the first UE 115 transmits the scheduling assistance message via the slot 0, m1 is one slot, and m2 is four slots, the resources indicated via the scheduling assistance message may be within slot 1 through slot 4.

In some examples, the threshold time period (e.g., the m1 and m2 values) may be configured by the network entity 105. For example, the threshold time period may be configured as part of the resource pool configuration, indicated via an RRC message, or indicated via a signal that triggers the resource preference reporting by the first UE 115, such as the resource selection trigger 320. In another example, the threshold time period may be defined according to one or more rules (e.g., predetermined or standardized). Additionally, or alternatively, the first UE 115 may determine the threshold time period based on one or more conditions associated with communications at the first UE 115, such as a packet delay budget (PDB). For example, the UE 115 may measure one or more metrics including a PDB and a respective range of measurements may map to a respective threshold time period. As such, the first UE 115 may ensure that the reported resources are within the PDB, such that the sidelink transmission may be performed with reduced latency (e.g., on time).

Accordingly, a first UE 115 and one or more other UEs 115 may monitor resources within a sensing window 310, decode SCI and other signaling received via the resources, measure an RSRP of the received signaling, and determine a set of available or reserved resources in a subsequent time period (e.g., the resource selection window 315). The one or more second UEs 115 may indicate the determined resources to the first UE 115 via inter-UE coordination messages. The first UE 115 may combine the resources determined by the first UE 115 with the resources indicated by the one or more second UEs 115 and transmit a scheduling assistance message to a network entity 105 that indicates the determined resource preference information. The network entity 105 may utilize the resource preference information to schedule sidelink communications, which may decrease power consumption at the first UE 115, improve throughput, and improve the quality of sidelink communications.

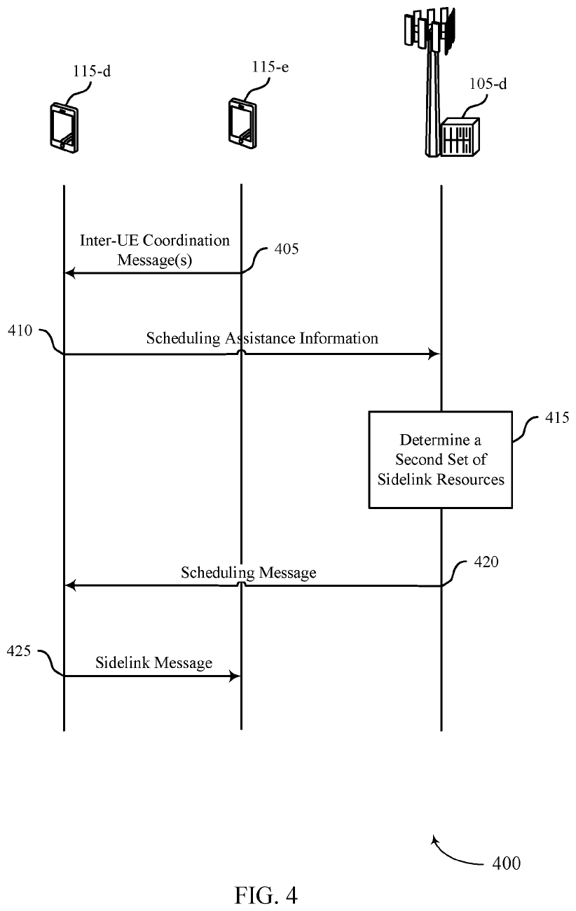

FIG. 4 illustrates an example of a process flow 400 that supports UE scheduling assistance for Mode 1 sidelink communications in accordance with one or more aspects of the present disclosure. The process flow 400 may implement or be implemented by aspects of the wireless communications systems 100 or 200. For example, process flow 400 may be implemented by UEs 115-d and 115-e and network entity 105-d, which may each represent examples of a UE 115 and a network entity 105 described with reference to FIGS. 1 through 3. The process flow 400 may be implemented by UEs 115-d and 115-e and network entity 105-d, for example, to identify available resources for sidelink transmission by the UE 115-d, as described with reference to FIGS. 2 through 3.

In the following description of the process flow 400, the operations may be performed in a different order than the order shown, or the operations performed by the UEs 115-d and 115-e may be performed in different orders or at different times. For example, specific operations may also be left out of the process flow 400, or other operations may be added to the process flow 400. Although the UEs 115-d and 115-e are shown performing the operations of the process flow 400, some aspects of some operations may also be performed by one or more other wireless devices.

At 405, in some examples, the UE 115-e may transmit one or more inter-UE coordination messages to the UE 115-d via a sidelink communication link. The one or more inter-UE coordination messages may each indicate one or mor sidelink resources based on a respective sidelink channel sensing procedure performed by the UE 115-e, as described with reference to FIGS. 2 and 3. In some examples, the multiple inter-UE coordination messages may include preferred resource information or non-preferred resource information.

In some examples, the UE 115-d may monitor for SCI from other UEs 115, such as the UE 115-d. The SCI may indicate multiple sidelink resources that are reserved for sidelink transmissions by the other UEs 115. In some examples, the SCI may include an ID of a respective cell associated with each of the multiple sidelink resources.

At 410, the UE 115-d may transmit SAI to the network entity 105-d via an uplink communication link. The SAI may indicate a first set of sidelink resources for sidelink communications by the UE 115-d. The UE 115-d may determine the first set of sidelink resources based on the multiple sidelink resources indicated via the multiple inter-UE coordination messages, the multiple sidelink resources indicated by the SCI, or both, as described with reference to FIGS. 2 and 3. In some examples, the UE 115-d may transmit the SAI based on the first set of resources being associated with one or more second cells that are different than a first cell associated with the UE 115-d.

In some examples, the UE 115-d may measure an RSRP corresponding to the first set of sidelink resources. The UE 115-d may compare the measured RSRP with an RSRP threshold. The UE 115-d may transmit the SAI based on the measured RSRP exceeding the RSRP threshold. In some examples, the UE 115-d may determine that a condition associated with the sidelink communications at the UE 115-d is satisfied. The condition may correspond to an inter-UE coordination message received by the UE 115-d, a quantity of NACKs received by the UE 115-d, or a measured CBR associated with a sidelink resource pool exceeding a threshold CBR. The UE 115-d may transmit the SAI based on determining that the condition is satisfied.

The SAI may indicate a time and frequency location of the first set of sidelink resources. In some examples, the network entity 105-d may transmit a control message to the UE 115-d that indicates an RSRP threshold for sidelink resource preference reporting, a trigger for resource preference reporting by the UE 115-d, or both. The first set of sidelink resources may correspond to resources preferred by the UE 115-d for the sidelink communications or resources non-preferred by the UE 115-d for the sidelink communications based on the control message.

In some examples, the UE 115-d may transmit the SAI in a first slot. The first set of sidelink resource indicated by the SAI may be located in a second slot that is less than a threshold time period from the first slot, as described with reference to FIG. 3. The SAI may be transmitted via a MAC-CE, a sidelink BSR, or an uplink control channel (e.g., a PUCCH).

At 415, the network entity 105-d may determine a second set of sidelink resources for the sidelink communications by the UE 115-d based on the first set of sidelink resources indicated by the SAI. In some examples, the network entity 105-d may determine whether the first set of sidelink resources indicated by the SAI includes resources allocated by the network entity 105-d or resources allocated by one or more other network entities 105. In some examples, the first set of sidelink resources may be associated with one or more second cells that are different than a first cell supported by the network entity 105-d, and the network entity 105-d may determine the second set of sidelink resources based on the first set of sidelink resources being associated with the one or more second cells.

At 420, the network entity 105-d may transmit a scheduling message to the UE 115-d. The scheduling message may allocate the second set of sidelink resources for the sidelink communications by the UE 115-d. The second set of sidelink resources may be based on the first set of sidelink resources indicated by the SAI. In some examples, the network entity 105-d may transmit the scheduling message based on determining whether the first set of sidelink resources indicated by the SAI includes resources allocated by the network entity 105-d or resources allocated by one or more other network entities 105.

At 425, the UE 115-d may transmit a sidelink message to the UE 115-e using the second set of sidelink resources allocated by the scheduling message.

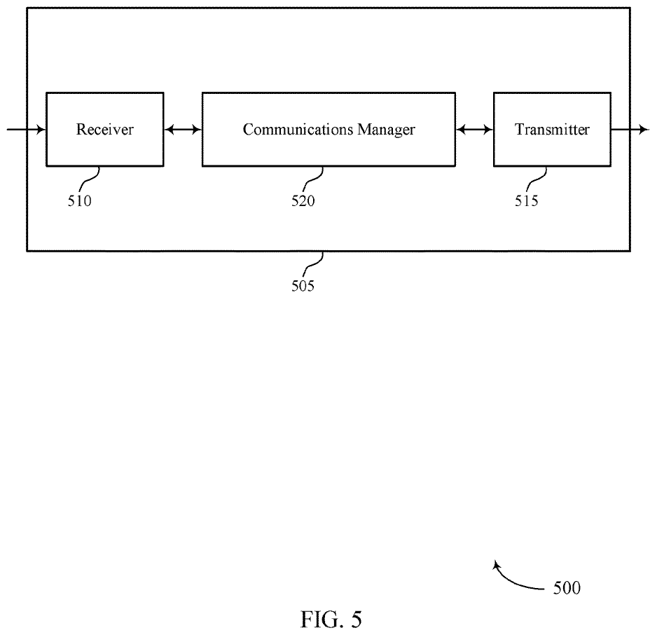

FIG. 5 shows a block diagram 500 of a device 505 that supports UE scheduling assistance for Mode 1 sidelink communications in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to UE scheduling assistance for Mode 1 sidelink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UE scheduling assistance for Mode 1 sidelink communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of UE scheduling assistance for Mode 1 sidelink communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting, via an uplink communication link, SAI that indicates a first set of sidelink resources for sidelink communications by the UE. The communications manager 520 may be configured as or otherwise support a means for receiving a scheduling message that allocates a second set of sidelink resources for the sidelink communications by the UE, the second set of sidelink resources based on the first set of sidelink resources indicated via the SAI. The communications manager 520 may be configured as or otherwise support a means for transmitting a sidelink message via the second set of sidelink resources allocated by the scheduling message.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing and reduced power consumption. For example, by transmitting SAI identifying available resources corresponding to resources the device 505 did not monitor, the processor of the device 505 may refrain from processing (e.g., monitoring and performing channel measurements) on each resource in a resource pool.

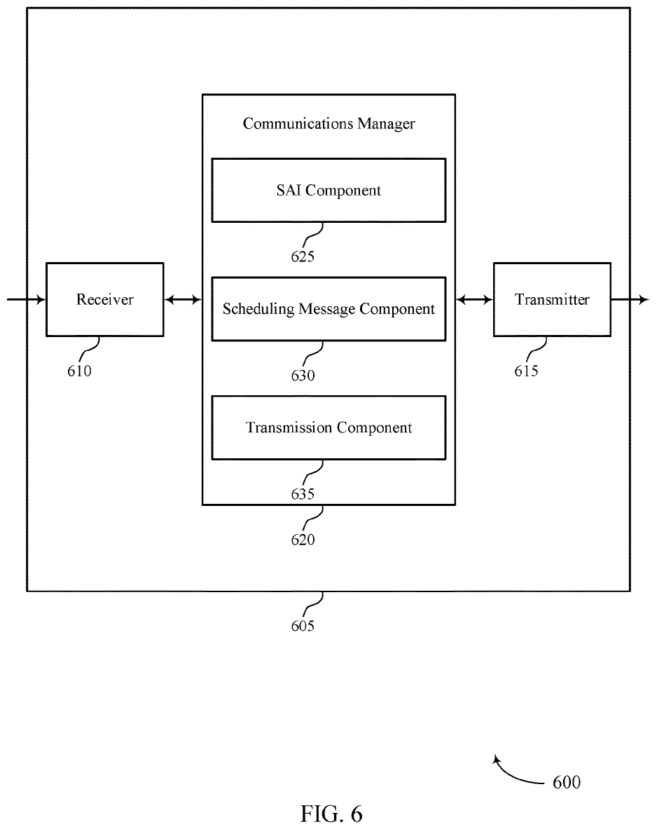

FIG. 6 shows a block diagram 600 of a device 605 that supports UE scheduling assistance for Mode 1 sidelink communications in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to UE scheduling assistance for Mode 1 sidelink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UE scheduling assistance for Mode 1 sidelink communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of UE scheduling assistance for Mode 1 sidelink communications as described herein. For example, the communications manager 620 may include a SAI component 625, a scheduling message component 630, a transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The SAI component 625 may be configured as or otherwise support a means for transmitting, via an uplink communication link, SAI that indicates a first set of sidelink resources for sidelink communications by the UE. The scheduling message component 630 may be configured as or otherwise support a means for receiving a scheduling message that allocates a second set of sidelink resources for the sidelink communications by the UE, the second set of sidelink resources based on the first set of sidelink resources indicated via the SAI. The transmission component 635 may be configured as or otherwise support a means for transmitting a sidelink message via the second set of sidelink resources allocated by the scheduling message.

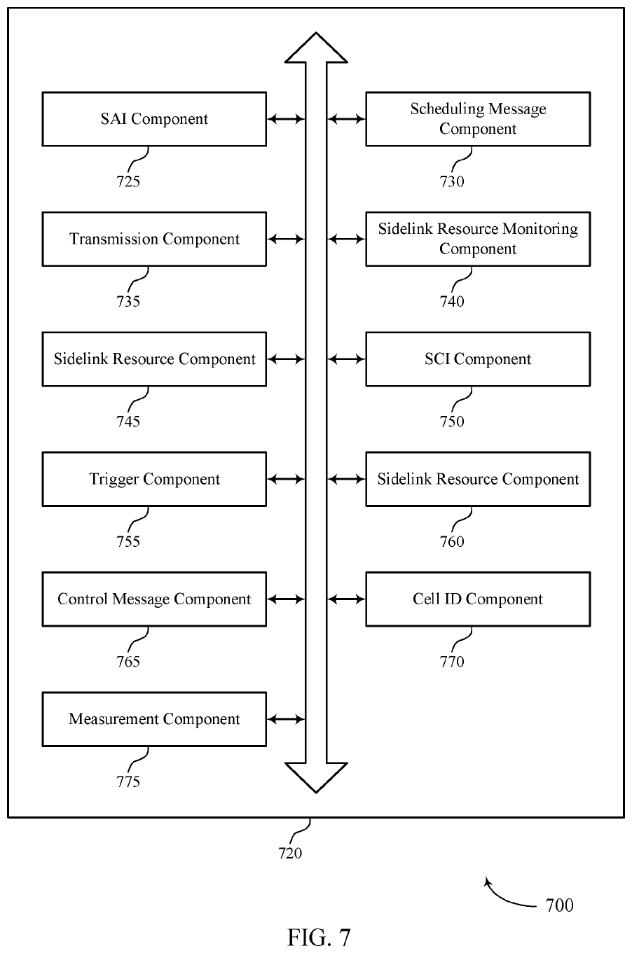

FIG. 7 shows a block diagram 700 of a communications manager 720 that supports UE scheduling assistance for Mode 1 sidelink communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of UE scheduling assistance for Mode 1 sidelink communications as described herein. For example, the communications manager 720 may include a SAI component 725, a scheduling message component 730, a transmission component 735, a sidelink resource monitoring component 740, a sidelink resource component 745, a SCI component 750, a trigger component 755, a sidelink resource component 760, a control message component 765, a cell ID component 770, a measurement component 775, or any combination thereof. Each of these components may communicate, directly or indirectly, with one another (e.g., via one or more buses).

The communications manager 720 may support wireless communication at a UE in accordance with examples as disclosed herein. The SAI component 725 may be configured as or otherwise support a means for transmitting, via an uplink communication link, SAI that indicates a first set of sidelink resources for sidelink communications by the UE. The scheduling message component 730 may be configured as or otherwise support a means for receiving a scheduling message that allocates a second set of sidelink resources for the sidelink communications by the UE, the second set of sidelink resources based on the first set of sidelink resources indicated via the SAI. The transmission component 735 may be configured as or otherwise support a means for transmitting a sidelink message via the second set of sidelink resources allocated by the scheduling message.

In some examples, the sidelink resource monitoring component 740 may be configured as or otherwise support a means for monitoring for SCI from one or more other UEs, the SCI indicating a set of multiple sidelink resources that are reserved for sidelink transmissions by the one or more other UEs, where the first set of sidelink resources indicated via the SAI is based on the SCI.

In some examples, to support transmitting the SAI, the transmission component 735 may be configured as or otherwise support a means for transmitting, via the SAI, an indication that the first set of sidelink resources is reserved based on the set of multiple sidelink resources indicated via the SCI including at least the first set of sidelink resources.

In some examples, the cell ID component 770 may be configured as or otherwise support a means for receiving, via the SCI, an ID of a respective cell associated with each of the set of multiple sidelink resources, where transmitting the indication that the first set of sidelink resources is reserved is based on the first set of sidelink resources being associated with one or more second cells that are different than a first cell associated with the UE.

In some examples, the measurement component 775 may be configured as or otherwise support a means for measuring a RSRP associated with the first set of sidelink resources. In some examples, the measurement component 775 may be configured as or otherwise support a means for comparing the measured RSRP with a RSRP threshold, where transmitting the indication of the first set of sidelink resources via the SAI is based on the measured RSRP exceeding the RSRP threshold.

In some examples, the sidelink resource component 745 may be configured as or otherwise support a means for receiving, via a sidelink communication link, one or more inter-UE coordination messages that each indicate one or more sidelink resources based on a respective sidelink channel sensing procedure, where transmitting the SAI is based on the one or more inter-UE coordination messages.

In some examples, the one or more inter-UE coordination messages include preferred resource information, and the sidelink resource component 760 may be configured as or otherwise support a means for determining that the first set of sidelink resources are common to the one or more sidelink resources indicated via each of the one or more inter-UE coordination messages, where transmitting the SAI that indicates the first set of sidelink resources is based on the determining.

In some examples, the one or more inter-UE coordination messages include non-preferred resource information, and the sidelink resource component 760 may be configured as or otherwise support a means for determining that the first set of sidelink resources includes a union of the one or more sidelink resources indicated via each of the one or more inter-UE coordination messages, where transmitting the SAI that indicates the first set of sidelink resources is based on the determining.

In some examples, the SCI component 750 may be configured as or otherwise support a means for monitoring for SCI in sidelink resources of a sidelink resource pool, where the SCI indicates a set of multiple sidelink resources that are reserved for sidelink transmissions by one or more second UEs. In some examples, the sidelink resource component 760 may be configured as or otherwise support a means for determining the first set of sidelink resources based on the one or more sidelink resources indicated via each of the one or more inter-UE coordination messages and the set of multiple sidelink resources indicated via the SCI, where transmitting the SAI is based on determining the first set of sidelink resources.

In some examples, the SCI component 750 may be configured as or otherwise support a means for determining that a condition associated with the sidelink communications at the UE is satisfied, where transmitting the SAI is based on determining that the condition is satisfied, and where the condition corresponds to an inter-UE coordination message received by the UE, a quantity of negative acknowledgments received by the UE exceeding a threshold quantity, or a measured channel busy ratio associated with a sidelink resource pool exceeding a threshold channel busy ratio.

In some examples, the trigger component 755 may be configured as or otherwise support a means for receiving a control message including a trigger for resource preference reporting by the UE, where transmitting the SAI is based on the trigger.

In some examples, the control message indicates whether the resource preference reporting by the UE corresponds to reporting sidelink resources that are preferred by the UE or non-preferred by the UE for the sidelink communications. In some examples, the SAI indicates a time and frequency location of the first set of sidelink resources, the first set of sidelink resources corresponding to resources preferred by the UE for the sidelink communications or resources non-preferred by the UE for the sidelink communications based on the control message.

In some examples, the sidelink resource component 760 may be configured as or otherwise support a means for determining the first set of sidelink resources based on a sidelink channel sensing procedure, one or more inter-UE coordination messages, or both in accordance with a capability of the UE.

In some examples, the control message component 765 may be configured as or otherwise support a means for receiving a control message that indicates a sidelink resource preference reporting configuration. In some examples, the sidelink resource component 760 may be configured as or otherwise support a means for determining the first set of sidelink resources based on a sidelink channel sensing procedure, one or more inter-UE coordination messages, or both in accordance with the sidelink resource preference reporting configuration.

In some examples, to support transmitting the SAI, the transmission component 735 may be configured as or otherwise support a means for transmitting the SAI via a first slot, where the first set of sidelink resources indicated via the SAI are located in a second slot that is less than a threshold time period from the first slot.

In some examples, to support transmitting the SAI, the transmission component 735 may be configured as or otherwise support a means for transmitting a medium access control-control element, a sidelink buffer status report, or an uplink control channel including the SAI.

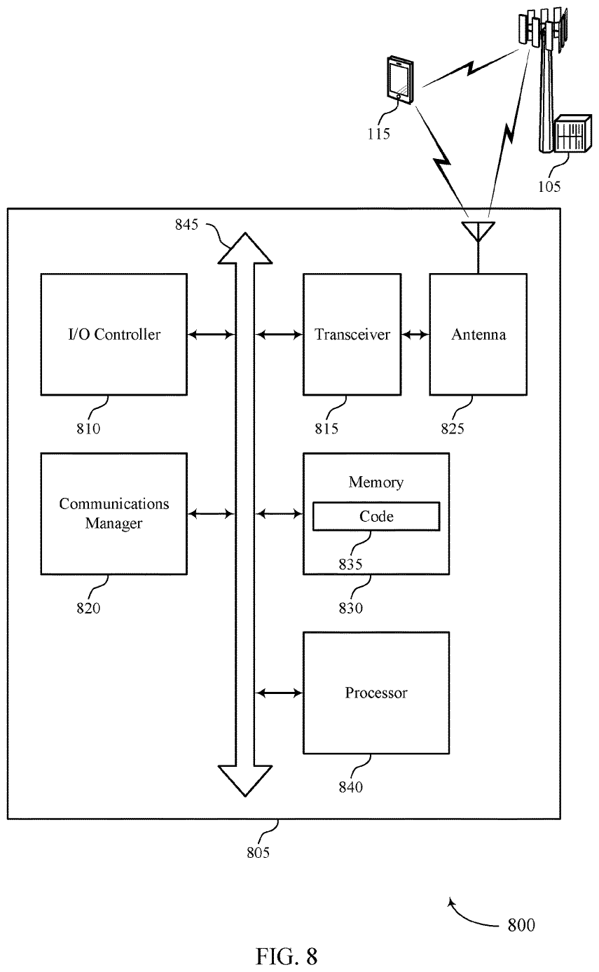

FIG. 8 shows a diagram of a system 800 including a device 805 that supports UE scheduling assistance for Mode 1 sidelink communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting UE scheduling assistance for Mode 1 sidelink communications). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting, via an uplink communication link, SAI that indicates a first set of sidelink resources for sidelink communications by the UE. The communications manager 820 may be configured as or otherwise support a means for receiving a scheduling message that allocates a second set of sidelink resources for the sidelink communications by the UE, the second set of sidelink resources based on the first set of sidelink resources indicated via the SAI. The communications manager 820 may be configured as or otherwise support a means for transmitting a sidelink message via the second set of sidelink resources allocated by the scheduling message.

By including or configuring the communications manager 820 in accordance with examples as described herein, the device 805 may support techniques for reduced latency, reduced power consumption, longer battery life, and improved utilization of processing capability. The device 805 may avoid increased latency that may be a result of transmitting SAI by determining that resources in a resource selection window that correspond to resources the device 805 did not monitor in a corresponding sensing window are available for sidelink transmission. The device 805 may thereby be configured with a resource reservation configuration that may permit some potential interference to better enable the sidelink device 805 to perform sidelink transmissions without collisions.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of UE scheduling assistance for Mode 1 sidelink communications as described herein, or the processor 840 and the memory 830 may be otherwise configured to perform or support such operations.

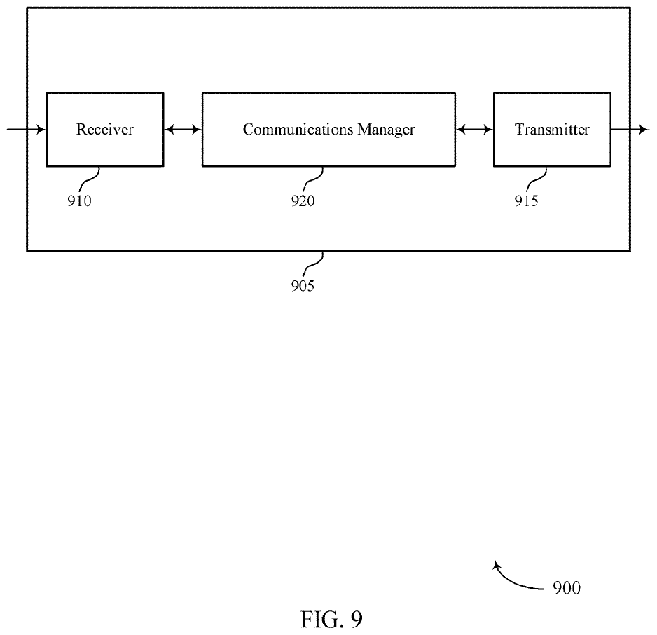

FIG. 9 shows a block diagram 900 of a device 905 that supports UE scheduling assistance for Mode 1 sidelink communications in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of UE scheduling assistance for Mode 1 sidelink communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for receiving, via an uplink communication link, SAI that indicates a first set of sidelink resources for sidelink communications by a UE. The communications manager 920 may be configured as or otherwise support a means for determining a second set of sidelink resources for the sidelink communications by the UE based on the first set of sidelink resources indicated via the SAI. The communications manager 920 may be configured as or otherwise support a means for transmitting a scheduling message that allocates the second set of sidelink resources for the sidelink communications by the UE.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and reduced power consumption. For example, by transmitting SAI identifying available resources corresponding to resources the device 505 did not monitor, the processor of the device 505 may refrain from processing (e.g., monitoring and performing channel measurements) on each resource in a resource pool.

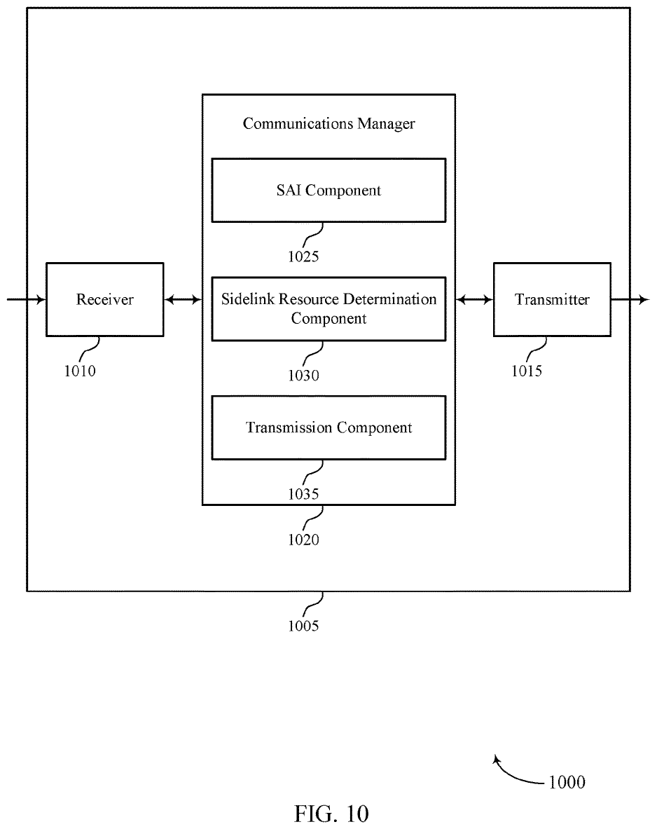

FIG. 10 shows a block diagram 1000 of a device 1005 that supports UE scheduling assistance for Mode 1 sidelink communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UE scheduling assistance for Mode 1 sidelink communications as described herein. For example, the communications manager 1020 may include a SAI component 1025, a sidelink resource determination component 1030, a transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The SAI component 1025 may be configured as or otherwise support a means for receiving, via an uplink communication link, SAI that indicates a first set of sidelink resources for sidelink communications by a UE. The sidelink resource determination component 1030 may be configured as or otherwise support a means for determining a second set of sidelink resources for the sidelink communications by the UE based on the first set of sidelink resources indicated via the SAI. The transmission component 1035 may be configured as or otherwise support a means for transmitting a scheduling message that allocates the second set of sidelink resources for the sidelink communications by the UE.

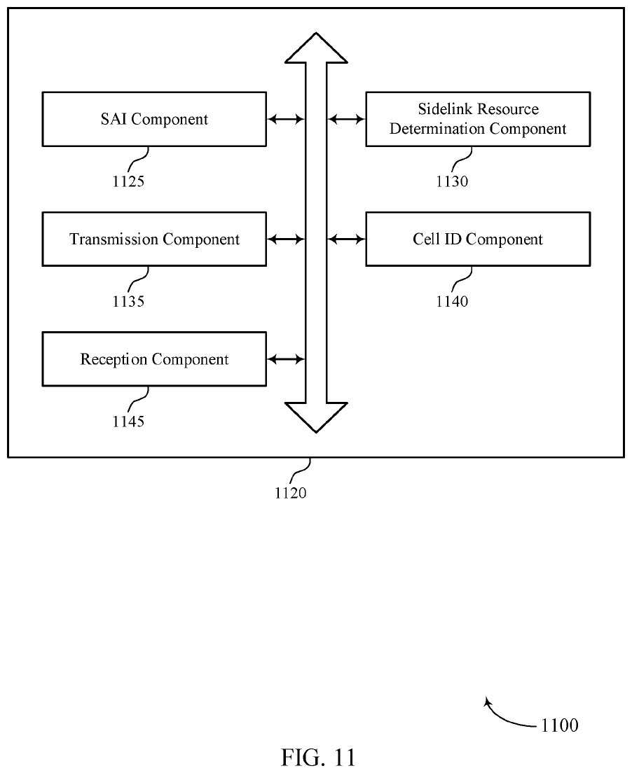

FIG. 11 shows a block diagram 1100 of a communications manager 1120 that supports UE scheduling assistance for Mode 1 sidelink communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UE scheduling assistance for Mode 1 sidelink communications as described herein. For example, the communications manager 1120 may include a SAI component 1125, a sidelink resource determination component 1130, a transmission component 1135, a cell ID component 1140, a reception component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The SAI component 1125 may be configured as or otherwise support a means for receiving, via an uplink communication link, SAI that indicates a first set of sidelink resources for sidelink communications by a UE. The sidelink resource determination component 1130 may be configured as or otherwise support a means for determining a second set of sidelink resources for the sidelink communications by the UE based on the first set of sidelink resources indicated via the SAI. The transmission component 1135 may be configured as or otherwise support a means for transmitting a scheduling message that allocates the second set of sidelink resources for the sidelink communications by the UE.

In some examples, the sidelink resource determination component 1130 may be configured as or otherwise support a means for determining whether the first set of sidelink resources indicated via the SAI include resources allocated by the network entity or resources allocated by one or more second network entities, where transmitting the scheduling message that allocates the second set of sidelink resources is based on the determining.

In some examples, the first set of sidelink resources indicated via the SAI is associated with one or more second cells that are different than a first cell supported by the network entity. In some examples, determining the second set of sidelink resources is based on the first set of sidelink resources being associated with the one or more second cells.

In some examples, the transmission component 1135 may be configured as or otherwise support a means for transmitting a control message that indicates a RSRP threshold for sidelink resource preference reporting, where receiving the SAI that indicates the first set of sidelink resources is based on the RSRP threshold.

In some examples, the transmission component 1135 may be configured as or otherwise support a means for transmitting a control message including a trigger for resource preference reporting by the UE, where receiving the SAI is based on the trigger.

In some examples, the control message indicates whether the resource preference reporting by the UE corresponds to reporting sidelink resources that are preferred by the UE or non-preferred by the UE for the sidelink communications. In some examples, the SAI indicates a time and frequency location of the first set of sidelink resources, the first set of sidelink resources corresponding to resources preferred by the UE for the sidelink communications or resources non-preferred by the UE for the sidelink communications based on the control message.

In some examples, the transmission component 1135 may be configured as or otherwise support a means for transmitting a control message that indicates a sidelink resource preference reporting configuration, where the first set of sidelink resources are based on a first sidelink channel sensing procedure at the UE, second sidelink channel sensing procedures at one or more second UEs, or both in accordance with the sidelink resource preference reporting configuration.

In some examples, to support receiving the SAI, the SAI component 1125 may be configured as or otherwise support a means for receiving the SAI via a first slot, where the first set of sidelink resources indicated via the SAI are located in a second slot that is less than a threshold time period from the first slot.

In some examples, to support receiving the SAI, the reception component 1145 may be configured as or otherwise support a means for receiving a medium access control-control element, a sidelink buffer status report, an uplink control channel, or any combination thereof including the SAI.

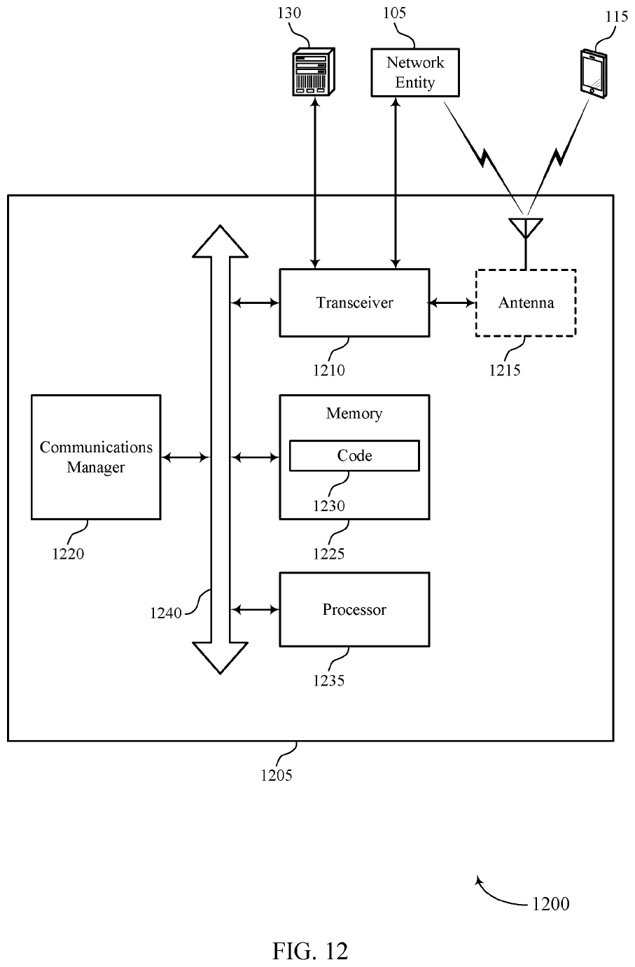

FIG. 12 shows a diagram of a system 1200 including a device 1205 that supports UE scheduling assistance for Mode 1 sidelink communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting UE scheduling assistance for Mode 1 sidelink communications). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for receiving, via an uplink communication link, SAI that indicates a first set of sidelink resources for sidelink communications by a UE. The communications manager 1220 may be configured as or otherwise support a means for determining a second set of sidelink resources for the sidelink communications by the UE based on the first set of sidelink resources indicated via the SAI. The communications manager 1220 may be configured as or otherwise support a means for transmitting a scheduling message that allocates the second set of sidelink resources for the sidelink communications by the UE.

By including or configuring the communications manager 1220 in accordance with examples as described herein, the device 1205 may support techniques for reduced latency, reduced power consumption, longer battery life, and improved utilization of processing capability. The device 805 may avoid increased latency that may be a result of transmitting SAI by determining that resources in a resource selection window that correspond to resources the device 805 did not monitor in a corresponding sensing window are available for sidelink transmission. The device 805 may thereby be configured with a resource reservation configuration that may permit some potential interference to better enable the sidelink device 805 to perform sidelink transmissions without collisions.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of UE scheduling assistance for Mode 1 sidelink communications as described herein, or the processor 1235 and the memory 1225 may be otherwise configured to perform or support such operations.

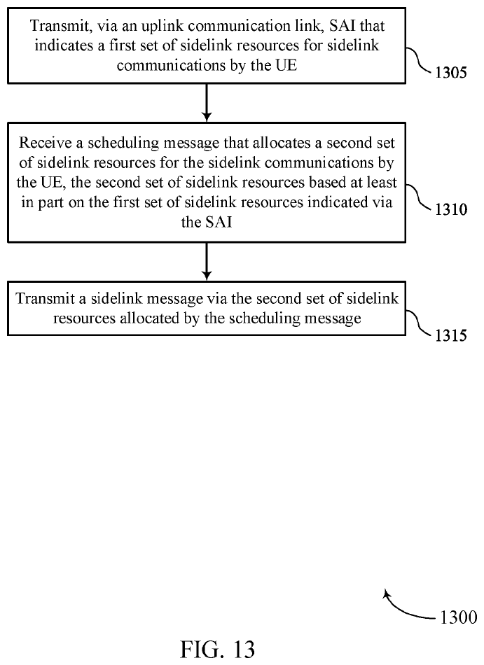

FIG. 13 shows a flowchart illustrating a method 1300 that supports UE scheduling assistance for Mode 1 sidelink communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, via an uplink communication link, SAI that indicates a first set of sidelink resources for sidelink communications by the UE. The operations of 1305 may be performed in accordance with examples as disclosed herein. In some examples, aspects of the operations of 1305 may be performed by a SAI component 725 as described with reference to FIG. 7.

At 1310, the method may include receiving a scheduling message that allocates a second set of sidelink resources for the sidelink communications by the UE, the second set of sidelink resources based on the first set of sidelink resources indicated via the SAI. The operations of 1310 may be performed in accordance with examples as disclosed herein. In some examples, aspects of the operations of 1310 may be performed by a scheduling message component 730 as described with reference to FIG. 7.

At 1315, the method may include transmitting a sidelink message via the second set of sidelink resources allocated by the scheduling message. The operations of 1315 may be performed in accordance with examples as disclosed herein. In some examples, aspects of the operations of 1315 may be performed by a transmission component 735 as described with reference to FIG. 7.

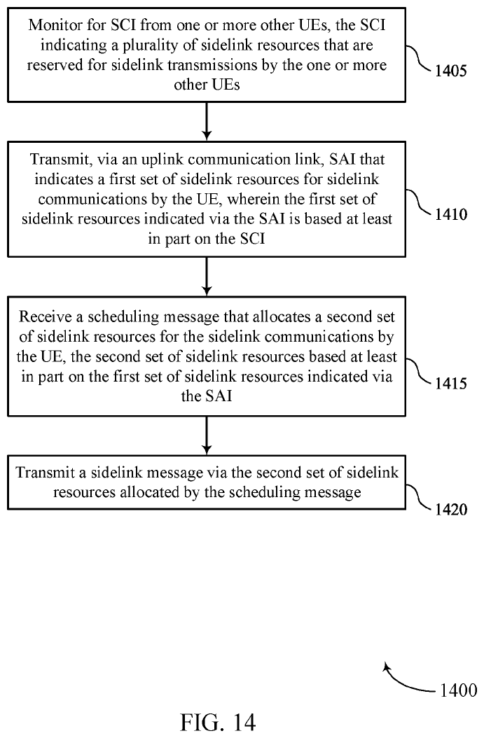

FIG. 14 shows a flowchart illustrating a method 1400 that supports UE scheduling assistance for Mode 1 sidelink communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include monitoring for SCI from one or more other UEs, the SCI indicating a set of multiple sidelink resources that are reserved for sidelink transmissions by the one or more other UEs. The operations of 1405 may be performed in accordance with examples as disclosed herein. In some examples, aspects of the operations of 1405 may be performed by a sidelink resource monitoring component 740 as described with reference to FIG. 7.

At 1410, the method may include transmitting, via an uplink communication link, SAI that indicates a first set of sidelink resources for sidelink communications by the UE, where the first set of sidelink resources indicated via the SAI is based on the SCI. The operations of 1410 may be performed in accordance with examples as disclosed herein. In some examples, aspects of the operations of 1410 may be performed by a SAI component 725 as described with reference to FIG. 7.

At 1415, the method may include receiving a scheduling message that allocates a second set of sidelink resources for the sidelink communications by the UE, the second set of sidelink resources based on the first set of sidelink resources indicated via the SAI. The operations of 1415 may be performed in accordance with examples as disclosed herein. In some examples, aspects of the operations of 1415 may be performed by a scheduling message component 730 as described with reference to FIG. 7.

At 1420, the method may include transmitting a sidelink message via the second set of sidelink resources allocated by the scheduling message. The operations of 1420 may be performed in accordance with examples as disclosed herein. In some examples, aspects of the operations of 1420 may be performed by a transmission component 735 as described with reference to FIG. 7.

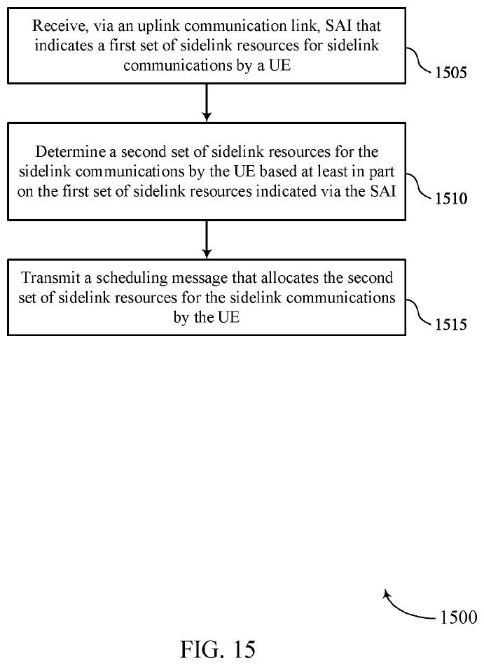

FIG. 15 shows a flowchart illustrating a method 1500 that supports UE scheduling assistance for Mode 1 sidelink communications in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, via an uplink communication link, SAI that indicates a first set of sidelink resources for sidelink communications by a UE. The operations of 1505 may be performed in accordance with examples as disclosed herein. In some examples, aspects of the operations of 1505 may be performed by a SAI component 1125 as described with reference to FIG. 11.

At 1510, the method may include determining a second set of sidelink resources for the sidelink communications by the UE based on the first set of sidelink resources indicated via the SAI. The operations of 1510 may be performed in accordance with examples as disclosed herein. In some examples, aspects of the operations of 1510 may be performed by a sidelink resource determination component 1130 as described with reference to FIG. 11.

At 1515, the method may include transmitting a scheduling message that allocates the second set of sidelink resources for the sidelink communications by the UE. The operations of 1515 may be performed in accordance with examples as disclosed herein. In some examples, aspects of the operations of 1515 may be performed by a transmission component 1135 as described with reference to FIG. 11.

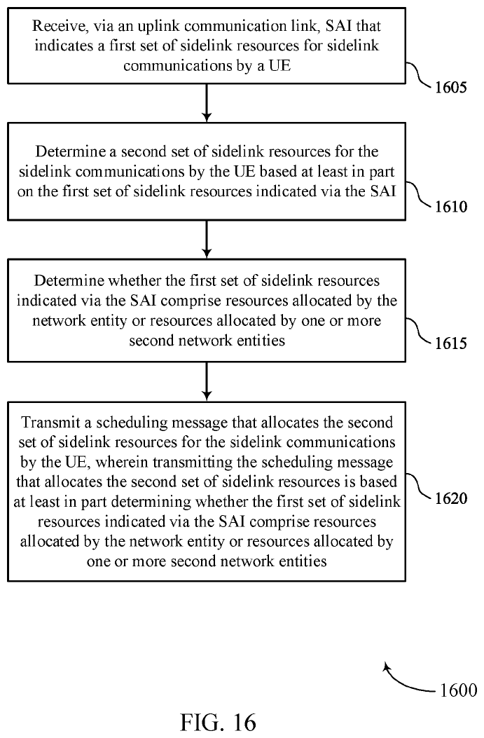

FIG. 16 shows a flowchart illustrating a method 1600 that supports UE scheduling assistance for Mode 1 sidelink communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving, via an uplink communication link, SAI that indicates a first set of sidelink resources for sidelink communications by a UE. The operations of 1605 may be performed in accordance with examples as disclosed herein. In some examples, aspects of the operations of 1605 may be performed by an SAI component 1125 as described with reference to FIG. 11.

At 1610, the method may include determining a second set of sidelink resources for the sidelink communications by the UE based on the first set of sidelink resources indicated via the SAI. The operations of 1610 may be performed in accordance with examples as disclosed herein. In some examples, aspects of the operations of 1610 may be performed by a sidelink resource determination component 1130 as described with reference to FIG. 11.

At 1615, the method may include determining whether the first set of sidelink resources indicated via the SAI include resources allocated by the network entity or resources allocated by one or more second network entities. The operations of 1615 may be performed in accordance with examples as disclosed herein. In some examples, aspects of the operations of 1615 may be performed by a sidelink resource determination component 1130 as described with reference to FIG. 11.

At 1620, the method may include transmitting a scheduling message that allocates the second set of sidelink resources for the sidelink communications by the UE, where transmitting the scheduling message that allocates the second set of sidelink resources is based on the determining. The operations of 1620 may be performed in accordance with examples as disclosed herein. In some examples, aspects of the operations of 1620 may be performed by a transmission component 1135 as described with reference to FIG. 11.

The following provides an overview of aspects of the present disclosure:

Aspect 1: A method for wireless communication at a UE, comprising: transmitting, via an uplink communication link, SAI that indicates a first set of sidelink resources for sidelink communications by the UE; receiving a scheduling message that allocates a second set of sidelink resources for the sidelink communications by the UE, the second set of sidelink resources based at least in part on the first set of sidelink resources indicated via the SAI; and transmitting a sidelink message via the second set of sidelink resources allocated by the scheduling message.

Aspect 2: The method of aspect 1, further comprising: monitoring for SCI from one or more other UEs, the SCI indicating a plurality of sidelink resources that are reserved for sidelink transmissions by the one or more other UEs, wherein the first set of sidelink resources indicated via the SAI is based at least in part on the SCI.

Aspect 3: The method of aspect 2, wherein transmitting the SAI comprises: transmitting, via the SAI, an indication that the first set of sidelink resources is reserved based at least in part on the plurality of sidelink resources indicated via the SCI comprising at least the first set of sidelink resources.

Aspect 4: The method of aspect 3, further comprising: receiving, via the SCI, an ID of a respective cell associated with each of the plurality of sidelink resources, wherein transmitting the indication that the first set of sidelink resources is reserved is based at least in part on the first set of sidelink resources being associated with one or more second cells that are different than a first cell associated with the UE.

Aspect 5: The method of any of aspects 3 through 4, further comprising: measuring a RSRP associated with the first set of sidelink resources; and comparing the measured RSRP with a RSRP threshold, wherein transmitting the indication of the first set of sidelink resources via the SAI is based at least in part on the measured RSRP exceeding the RSRP threshold.

Aspect 6: The method of any of aspects 1 through 5, further comprising: receiving, via a sidelink communication link, one or more inter-UE coordination messages that each indicate one or more sidelink resources based at least in part on a respective sidelink channel sensing procedure, wherein transmitting the SAI is based at least in part on the one or more inter-UE coordination messages.

Aspect 7: The method of aspect 6, wherein the one or more inter-UE coordination messages comprise preferred resource information, the method further comprising: determining that the first set of sidelink resources are common to the one or more sidelink resources indicated via each of the one or more inter-UE coordination messages, wherein transmitting the SAI that indicates the first set of sidelink resources is based at least in part on the determining.

Aspect 8: The method of aspect 6, wherein the one or more inter-UE coordination messages comprise non-preferred resource information, the method further comprising: determining that the first set of sidelink resources comprises a union of the one or more sidelink resources indicated via each of the one or more inter-UE coordination messages, wherein transmitting the SAI that indicates the first set of sidelink resources is based at least in part on the determining.

Aspect 9: The method of any of aspects 6 through 8, further comprising: monitoring for SCI in sidelink resources of a sidelink resource pool, wherein the SCI indicates a plurality of sidelink resources that are reserved for sidelink transmissions by one or more second UEs; and determining the first set of sidelink resources based at least in part on the one or more sidelink resources indicated via each of the one or more inter-UE coordination messages and the plurality of sidelink resources indicated via the SCI, wherein transmitting the SAI is based at least in part on determining the first set of sidelink resources.

Aspect 10: The method of any of aspects 1 through 9, further comprising: determining that a condition associated with the sidelink communications at the UE is satisfied, wherein transmitting the SAI is based at least in part on determining that the condition is satisfied, and wherein the condition corresponds to an inter-UE coordination message received by the UE, a quantity of negative acknowledgments received by the UE exceeding a threshold quantity, or a measured CBR associated with a sidelink resource pool exceeding a threshold CBR.

Aspect 11: The method of any of aspects 1 through 10, further comprising: receiving a control message comprising a trigger for resource preference reporting by the UE, wherein transmitting the SAI is based at least in part on the trigger.

Aspect 12: The method of aspect 11, wherein the control message indicates whether the resource preference reporting by the UE corresponds to reporting sidelink resources that are preferred by the UE or non-preferred by the UE for the sidelink communications; and the SAI indicates a time and frequency location of the first set of sidelink resources, the first set of sidelink resources corresponding to resources preferred by the UE for the sidelink communications or resources non-preferred by the UE for the sidelink communications based at least in part on the control message.

Aspect 13: The method of any of aspects 1 through 12, further comprising: determining the first set of sidelink resources based at least in part on a sidelink channel sensing procedure, one or more inter-UE coordination messages, or both in accordance with a capability of the UE.

Aspect 14: The method of any of aspects 1 through 13, further comprising: receiving a control message that indicates a sidelink resource preference reporting configuration; and determining the first set of sidelink resources based at least in part on a sidelink channel sensing procedure, one or more inter-UE coordination messages, or both in accordance with the sidelink resource preference reporting configuration.

Aspect 15: The method of any of aspects 1 through 14, wherein transmitting the SAI comprises: transmitting the SAI via a first slot, wherein the first set of sidelink resources indicated via the SAI are located in a second slot that is less than a threshold time period from the first slot.

Aspect 16: The method of any of aspects 1 through 15, wherein transmitting the SAI comprises: transmitting a medium access control-control element, a sidelink buffer status report, or an uplink control channel comprising the SAI.

Aspect 17: A method for wireless communication at a network entity, comprising: obtaining, via an uplink communication link, SAI that indicates a first set of sidelink resources for sidelink communications by a UE; determining a second set of sidelink resources for the sidelink communications by the UE based at least in part on the first set of sidelink resources indicated via the SAI; and outputting a scheduling message that allocates the second set of sidelink resources for the sidelink communications by the UE.

Aspect 18: The method of aspect 17, further comprising: determining whether the first set of sidelink resources indicated via the SAI comprise resources allocated by the network entity or resources allocated by one or more second network entities, wherein outputting the scheduling message that allocates the second set of sidelink resources is based at least in part on the determining.

Aspect 19: The method of any of aspects 17 through 18, wherein the first set of sidelink resources indicated via the SAI is associated with one or more second cells that are different than a first cell supported by the network entity; and determining the second set of sidelink resources is based at least in part on the first set of sidelink resources being associated with the one or more second cells.

Aspect 20: The method of any of aspects 17 through 19, further comprising: outputting a control message that indicates an RSRP threshold for sidelink resource preference reporting, wherein obtaining the SAI that indicates the first set of sidelink resources is based at least in part on the RSRP threshold.

Aspect 21: The method of any of aspects 17 through 20, further comprising: outputting a control message comprising a trigger for resource preference reporting by the UE, wherein obtaining the SAI is based at least in part on the trigger.

Aspect 22: The method of aspect 21, wherein the control message indicates whether the resource preference reporting by the UE corresponds to reporting sidelink resources that are preferred by the UE or non-preferred by the UE for the sidelink communications; and the SAI indicates a time and frequency location of the first set of sidelink resources, the first set of sidelink resources corresponding to resources preferred by the UE for the sidelink communications or resources non-preferred by the UE for the sidelink communications based at least in part on the control message.

Aspect 23: The method of any of aspects 17 through 22, further comprising: outputting a control message that indicates a sidelink resource preference reporting configuration, wherein the first set of sidelink resources are based at least in part on a first channel sensing procedure at the UE, second channel sensing procedures at one or more second UEs, or both in accordance with the sidelink resource preference reporting configuration.

Aspect 24: The method of any of aspects 17 through 23, wherein obtaining the SAI comprises: obtaining the SAI via a first slot, wherein the first set of sidelink resources indicated via the SAI are located in a second slot that is less than a threshold time period from the first slot.

Aspect 25: The method of any of aspects 17 through 24, wherein obtaining the SAI comprises: obtaining a medium access control-control element, a sidelink buffer status report, an uplink control channel, or any combination thereof comprising the SAI.

Aspect 26: An apparatus for wireless communication at a UE, comprising a processor; memory coupled with the processor; and instructions stored in the memory and executable by the processor to cause the apparatus to perform a method of any of aspects 1 through 16.

Aspect 27: An apparatus for wireless communication at a UE, comprising at least one means for performing a method of any of aspects 1 through 16.

Aspect 28: A non-transitory computer-readable medium storing code for wireless communication at a UE, the code comprising instructions executable by a processor to perform a method of any of aspects 1 through 16.

Aspect 29: An apparatus for wireless communication at a network entity, comprising a processor; memory coupled with the processor; and instructions stored in the memory and executable by the processor to cause the apparatus to perform a method of any of aspects 17 through 25.

Aspect 30: An apparatus for wireless communication at a network entity, comprising at least one means for performing a method of any of aspects 17 through 25.

Aspect 31: A non-transitory computer-readable medium storing code for wireless communication at a network entity, the code comprising instructions executable by a processor to perform a method of any of aspects 17 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
transmit, via an uplink communication link, scheduling assistance information that indicates a first set of sidelink resources for sidelink communications by the UE;
receive a scheduling message that allocates a second set of sidelink resources for the sidelink communications by the UE, the second set of sidelink resources based at least in part on the first set of sidelink resources indicated via the scheduling assistance information; and
transmit a sidelink message via the second set of sidelink resources allocated by the scheduling message.

2. The apparatus of claim 1, wherein the instructions are further executable by the processor to cause the apparatus to:
monitor for sidelink control information from one or more other UEs, the sidelink control information indicating a plurality of sidelink resources that are reserved for sidelink transmissions by the one or more other UEs, wherein the first set of sidelink resources indicated via the scheduling assistance information is based at least in part on the sidelink control information.

3. The apparatus of claim 2, wherein the instructions to transmit the scheduling assistance information are executable by the processor to cause the apparatus to:
transmit, via the scheduling assistance information, an indication that the first set of sidelink resources is reserved based at least in part on the plurality of sidelink resources indicated via the sidelink control information comprising at least the first set of sidelink resources.

4. The apparatus of claim 3, wherein the instructions are further executable by the processor to cause the apparatus to:
receive, via the sidelink control information, an identifier of a respective cell associated with each of the plurality of sidelink resources, wherein transmitting the indication that the first set of sidelink resources is reserved is based at least in part on the first set of sidelink resources being associated with one or more second cells that are different than a first cell associated with the UE.

5. The apparatus of claim 3, wherein the instructions are further executable by the processor to cause the apparatus to:
measure a reference signal received power associated with the first set of sidelink resources; and
compare the measured reference signal received power with a reference signal received power threshold, wherein transmitting the indication of the first set of sidelink resources via the scheduling assistance information is based at least in part on the measured reference signal received power exceeding the reference signal received power threshold.

6. The apparatus of claim 1, wherein the instructions are further executable by the processor to cause the apparatus to:
receive, via a sidelink communication link, one or more inter-UE coordination messages that each indicate one or more sidelink resources based at least in part on a respective sidelink channel sensing procedure, wherein transmitting the scheduling assistance information is based at least in part on the one or more inter-UE coordination messages.

7. The apparatus of claim 6, wherein the one or more inter-UE coordination messages comprise preferred resource information, and the instructions are further executable by the processor to cause the apparatus to:
determine that the first set of sidelink resources are common to the one or more sidelink resources indicated via each of the one or more inter-UE coordination messages, wherein transmitting the scheduling assistance information that indicates the first set of sidelink resources is based at least in part on the determining.

8. The apparatus of claim 6, wherein the one or more inter-UE coordination messages comprise non-preferred resource information, and the instructions are further executable by the processor to cause the apparatus to:
determine that the first set of sidelink resources comprises a union of the one or more sidelink resources indicated via each of the one or more inter-UE coordination messages, wherein transmitting the scheduling assistance information that indicates the first set of sidelink resources is based at least in part on the determining.

9. The apparatus of claim 6, wherein the instructions are further executable by the processor to cause the apparatus to:
monitor for sidelink control information in sidelink resources of a sidelink resource pool, wherein the sidelink control information indicates a plurality of sidelink resources that are reserved for sidelink transmissions by one or more second UEs; and
determine the first set of sidelink resources based at least in part on the one or more sidelink resources indicated via each of the one or more inter-UE coordination messages and the plurality of sidelink resources indicated via the sidelink control information, wherein transmitting the scheduling assistance information is based at least in part on determining the first set of sidelink resources.

10. The apparatus of claim 1, wherein the instructions are further executable by the processor to cause the apparatus to:
determine that a condition associated with the sidelink communications at the UE is satisfied, wherein transmitting the scheduling assistance information is based at least in part on determining that the condition is satisfied, and wherein the condition corresponds to an inter-UE coordination message received by the UE, a quantity of negative acknowledgments received by the UE exceeding a threshold quantity, or a measured channel busy ratio associated with a sidelink resource pool exceeding a threshold channel busy ratio.

11. The apparatus of claim 1, wherein the instructions are further executable by the processor to cause the apparatus to:
receive a control message comprising a trigger for resource preference reporting by the UE, wherein transmitting the scheduling assistance information is based at least in part on the trigger.

12. The apparatus of claim 11, wherein:
the control message indicates whether the resource preference reporting by the UE corresponds to reporting sidelink resources that are preferred by the UE or non-preferred by the UE for the sidelink communications; and
the scheduling assistance information indicates a time and frequency location of the first set of sidelink resources, the first set of sidelink resources corresponding to resources preferred by the UE for the sidelink communications or resources non-preferred by the UE for the sidelink communications based at least in part on the control message.

13. The apparatus of claim 1, wherein the instructions are further executable by the processor to cause the apparatus to:
determine the first set of sidelink resources based at least in part on a sidelink channel sensing procedure, one or more inter-UE coordination messages, or both in accordance with a capability of the UE.

14. The apparatus of claim 1, wherein the instructions are further executable by the processor to cause the apparatus to:
receive a control message that indicates a sidelink resource preference reporting configuration; and
determine the first set of sidelink resources based at least in part on a sidelink channel sensing procedure, one or more inter-UE coordination messages, or both in accordance with the sidelink resource preference reporting configuration.

15. The apparatus of claim 1, wherein the instructions to transmit the scheduling assistance information are executable by the processor to cause the apparatus to:
transmit the scheduling assistance information via a first slot, wherein the first set of sidelink resources indicated via the scheduling assistance information are located in a second slot that is less than a threshold time period from the first slot.

16. The apparatus of claim 1, wherein the instructions to transmit the scheduling assistance information are executable by the processor to cause the apparatus to:
transmit a medium access control-control element, a sidelink buffer status report, or an uplink control channel comprising the scheduling assistance information.

17. An apparatus for wireless communication at a network entity, comprising:
a processor;
memory coupled with the processor; and
instructions stored in the memory and executable by the processor to cause the apparatus to:
obtain, via an uplink communication link, scheduling assistance information that indicates a first set of sidelink resources for sidelink communications by a user equipment (UE);
determine a second set of sidelink resources for the sidelink communications by the UE based at least in part on the first set of sidelink resources indicated via the scheduling assistance information; and
output a scheduling message that allocates the second set of sidelink resources for the sidelink communications by the UE.

18. The apparatus of claim 17, wherein the instructions are further executable by the processor to cause the apparatus to:
determine whether the first set of sidelink resources indicated via the scheduling assistance information comprise resources allocated by the network entity or resources allocated by one or more second network entities, wherein outputting the scheduling message that allocates the second set of sidelink resources is based at least in part on the determining.

19. The apparatus of claim 17, wherein:
the first set of sidelink resources indicated via the scheduling assistance information is associated with one or more second cells that are different than a first cell supported by the network entity, and
determining the second set of sidelink resources is based at least in part on the first set of sidelink resources being associated with the one or more second cells.

20. The apparatus of claim 17, wherein the instructions are further executable by the processor to cause the apparatus to:
output a control message that indicates a reference signal received power threshold for sidelink resource preference reporting, wherein obtaining the scheduling assistance information that indicates the first set of sidelink resources is based at least in part on the reference signal received power threshold.

21. The apparatus of claim 17, wherein the instructions are further executable by the processor to cause the apparatus to:
output a control message comprising a trigger for resource preference reporting by the UE, wherein obtaining the scheduling assistance information is based at least in part on the trigger.

22. The apparatus of claim 21, wherein:
the control message indicates whether the resource preference reporting by the UE corresponds to reporting sidelink resources that are preferred by the UE or non-preferred by the UE for the sidelink communications; and
the scheduling assistance information indicates a time and frequency location of the first set of sidelink resources, the first set of sidelink resources corresponding to resources preferred by the UE for the sidelink communications or resources non-preferred by the UE for the sidelink communications based at least in part on the control message.

23. The apparatus of claim 17, wherein the instructions are further executable by the processor to cause the apparatus to:
output a control message that indicates a sidelink resource preference reporting configuration, wherein the first set of sidelink resources are based at least in part on a first channel sensing procedure at the UE, second channel sensing procedures at one or more second UEs, or both in accordance with the sidelink resource preference reporting configuration.

24. The apparatus of claim 17, wherein the instructions to obtain the scheduling assistance information are executable by the processor to cause the apparatus to:
obtain the scheduling assistance information via a first slot, wherein the first set of sidelink resources indicated via the scheduling assistance information are located in a second slot that is less than a threshold time period from the first slot.

25. The apparatus of claim 17, wherein the instructions to obtain the scheduling assistance information are executable by the processor to cause the apparatus to:
obtain a medium access control-control element, a sidelink buffer status report, an uplink control channel, or any combination thereof comprising the scheduling assistance information.

26. A method for wireless communication at a user equipment (UE), comprising:
transmitting, via an uplink communication link, scheduling assistance information that indicates a first set of sidelink resources for sidelink communications by the UE;
receiving a scheduling message that allocates a second set of sidelink resources for the sidelink communications by the UE, the second set of sidelink resources based at least in part on the first set of sidelink resources indicated via the scheduling assistance information; and
transmitting a sidelink message via the second set of sidelink resources allocated by the scheduling message.

27. The method of claim 26, further comprising:
monitoring for sidelink control information from one or more other UEs, the sidelink control information indicating a plurality of sidelink resources that are reserved for sidelink transmissions by the one or more other UEs, wherein the first set of sidelink resources indicated via the scheduling assistance information is based at least in part on the sidelink control information.

28. The method of claim 27, wherein transmitting the scheduling assistance information comprises:
transmitting, via the scheduling assistance information, an indication that the first set of sidelink resources is reserved based at least in part on the plurality of sidelink resources indicated via the sidelink control information comprising at least the first set of sidelink resources.

29. A method for wireless communication at a network entity, comprising:
obtaining, via an uplink communication link, scheduling assistance information that indicates a first set of sidelink resources for sidelink communications by a user equipment (UE);
determining a second set of sidelink resources for the sidelink communications by the UE based at least in part on the first set of sidelink resources indicated via the scheduling assistance information; and
outputting a scheduling message that allocates the second set of sidelink resources for the sidelink communications by the UE.

30. The method of claim 29, further comprising:
determining whether the first set of sidelink resources indicated via the scheduling assistance information comprise resources allocated by the network entity or resources allocated by one or more second network entities, wherein outputting the scheduling message that allocates the second set of sidelink resources is based at least in part on the determining.
